(19) United States
(12) Patent Application Publication
(10) Pub. No.: US 2026/0239323 A1
(43) Pub. Date: Aug. 13, 2026

(54) TERMINAL AND COMMUNICATION METHOD

(71) Applicant: NTT DOCOMO, INC., Tokyo (JP)

(72) Inventors: Mayuko Okano, Chiyoda-ku, Tokyo (JP); Shinya Kumagai, Chiyoda-ku, Tokyo (JP); Shohei Yoshioka, Chiyoda-ku, Tokyo (JP); Hiroki Harada, Chiyoda-ku, Tokyo (JP)

(73) Assignee: NTT DOCOMO, INC., Tokyo (JP)

(21) Appl. No.: 19/152,605

(22) PCT Filed: Feb. 16, 2023
(86) PCT No.: PCT/JP2023/005575

§ 371 Date: Jul. 31, 2025

(51) Int. Cl. H04W 72/0457; H04W 72/1273; H04W 74/0833

(52) U.S. Cl. CPC H04W 72/0457; H04W 72/1273; H04W 74/0833

(57) ABSTRACT

A terminal includes: a control unit configured to control a process of reception of frequency-division multiplexed first shared channel and second shared channel; and a reception unit configured to receive the first shared channel and the second shared channel, based on the process of reception. The terminal has a capability of processing a predetermined bandwidth or less per unit time. The control unit controls the process of reception, based on the predetermined bandwidth, a first bandwidth that is allocated to the first shared channel, and a second bandwidth that is allocated to the second shared channel.

### TECHNICAL FIELD

The present invention relates to a terminal and a communication method in a wireless communication system.

### BACKGROUND ART

Regarding NR (New Radio) (also referred to as “5G”), or a successor system to LTE (Long Term Evolution), technologies have been discussed which satisfy the following requirements: a high capacity system, high data transmission rate, low delay, simultaneous connection of multiple terminals, low cost, power saving, etc. (for example, Non-Patent Literature 1).

In LTE or NR, a UE category or a UE capability for the function-reduced IoT (Internet of Things) in which functions, such functions related/reception bandwidth part or the number of antennas, to be supported as mandatory by normal terminals are removed. For example, in LTE, eMTC (enhanced Machine Type Communication), NB-IOT (Narrow Band IoT), etc., are defined, and in NR, RedCap (Reduced Capability), etc., are defined. In addition, in the future systems (for example, NR release 18 and 6G that is an NR successor system), the eRedCap (enhanced Reduced Capability) UE (User Equipment) is being discussed.

### CITATION LIST

### Non-Patent Literature

Non-Patent Literature 1: 3GPP TS 38.300 V 17.3.0 (2022-12)
Non-Patent Literature 2: 3 GPP TS 38.214 V 17.4.0 (2022-12)
Non-Patent Literature 3: 3GPP TS 38.213 V 17.4.0 (2022-12)

### SUMMARY OF INVENTION

### Technical Problem

However, there is a possibility that the capability-reduced eRedCap UE cannot appropriately receive a frequency-division multiplexed shared channel.

The present invention has been made in view of the above points, and it is an object of the present invention for the capability-reduced terminal to appropriately perform processing of receiving a frequency-division multiplexed shared channel in the wireless communication system.

### Solution to Problem

According to the disclosed technique, a terminal is provided. The terminal includes: a control unit configured to control a process of reception of frequency-division multiplexed first shared channel and second shared channel; and a reception unit configured to receive the first shared channel and the second shared channel, based on the process of reception. The terminal has a capability of processing a predetermined bandwidth or less per unit time, and the control unit controls the process of reception, based on the predetermined bandwidth, a first bandwidth that is allocated to the first shared channel, and a second bandwidth that is allocated to the second shared channel.

### Advantageous Effects of Invention

According to the disclosed technique, a reduced capability terminal can appropriately perform a reception process of frequency-division multiplexed shared channels in the wireless communication system.

### BRIEF DESCRIPTION OF DRAWINGS

FIG. 1 is a drawing illustrating an example of a configuration of a wireless communication system in an embodiment of the present invention.

FIG. 2 is a drawing illustrating an example of frequency-division multiplexing of shared channels in the first embodiment.

FIG. 3 is a drawing illustrating an example of frequency-division multiplexing of shared channels in the first embodiment.

FIG. 4 is a drawing illustrating an example of frequency-division multiplexing of shared channels in the second embodiment.

FIG. 5 is a drawing illustrating an example of frequency-division multiplexing of shared channels in the second embodiment.

FIG. 6 is a drawing illustrating an example of frequency-division multiplexing of shared channels in the second embodiment.

FIG. 7 is a drawing illustrating an example of frequency-division multiplexing of shared channels in the second embodiment.

FIG. 8 is a drawing illustrating an example of frequency-division multiplexing of shared channels in the second embodiment.

FIG. 9 is a drawing illustrating an example of frequency-division multiplexing of shared channels in the second embodiment.

FIG. 10 is a flowchart illustrating an example of an operation of receiving the frequency-division multiplexed shared channels in the third embodiment.

FIG. 11 is a flowchart illustrating an example of an operation of receiving the frequency-division multiplexed shared channels in the third embodiment.

FIG. 12 is a drawing illustrating an example of a functional structure of a base station 10 in an embodiment of the present invention.

FIG. 13 is drawing illustrating an example of a functional structure of a terminal 20 in an embodiment of the present invention.

FIG. 14 is a drawing illustrating an example of a hardware structure of the base station 10 or the terminal 20 in an embodiment of the present invention.

FIG. 15 is a drawing illustrating an example of a structure of a vehicle 2001 in an embodiment of the present invention.

### DESCRIPTION OF EMBODIMENTS

Hereinafter, one or more embodiments of the present invention will be described by referring to the drawings. It is to be noted that the embodiments described below are examples. Embodiments of the present invention are not limited to the following embodiments.

In an operation of a wireless communication system according to an embodiment the present invention, the conventional techniques will be used appropriately. It should be noted that, although the conventional techniques may be the conventional LTE, the conventional techniques are not limited to the conventional LTE. Further, it is assumed that the term “LTE” used in the present specification has, unless otherwise specifically mentioned, a broad meaning including a scheme of LTE-Advanced and a scheme after LTE-Advanced (e.g., NR).

In the embodiments described below, terms that are used in the conventional LTE are used, such as SS (Synchronization signal), PSS (Primary SS), SSS (Secondary SS), PBCH (Physical broadcast channel), PRACH (Physical random access channel), PDCCH (Physical Downlink Control Channel), PDSCH (Physical Downlink Shared Channel), PUCCH (Physical Uplink Control Channel), PUSCH (Physical Uplink Shared Channel), etc. The above-described terms are used for the sake of description convenience. Signals, functions, etc., which are similar to the above-described terms, may be referred to as different names. In addition, the above-described terms in NR correspond to NR-SS, NR-PSS, NR-SSS, NR-PBCH, NR-PRACH, etc. However, even when a signal is used for NR, the signal is not required to be referred to as “NR-”.

In addition, in an embodiment of the present invention, the duplex method may be a TDD (Time Division Duplex) method, an FDD (Frequency Division Duplex) method, or any other method (e. g., Flexible Duplex, or the like).

In addition, in an embodiment of the present invention, the expression, a radio parameter is “configured” may mean that a predetermined value is pre-configured, or may mean that a radio parameter indicated by a base station 10 or a terminal 20 is configured.

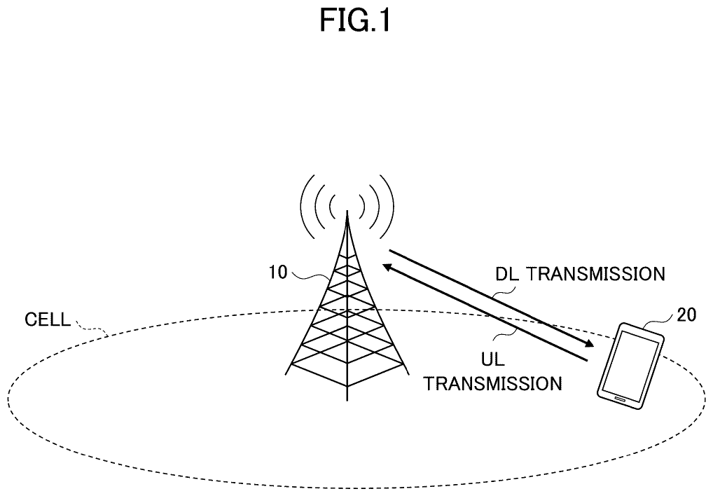

FIG. 1 is a drawing illustrating a configuration example (1) of a wireless communication system in an embodiment of the present invention. As illustrated in FIG. 1, a wireless communication system in an embodiment of the present invention includes a base station 10 and a terminal 20. In FIG. 1, a single base station 10 and a single terminal 20 are illustrated as an example, but there may be a plurality of base stations 10 and a plurality of terminals 20.

The base station 10 is a communication device that provides one or more cells and performs wireless communication with the terminal 20. Physical resources of radio signals may be defined in the time domain and the frequency domain, the time domain may be defined by the number of OFDM (Orthogonal Frequency Division Multiplexing) symbols, and the frequency domain may be defined by the number of sub-carriers or resource blocks. The base station 10 transmits a synchronization signal and system information to the terminal 20. The synchronization signal is, for example, an NR-PSS and/or an NR-SSS. The system information may be transmitted via an NR-PBCH, and may be referred to as broadcast information. The synchronization signal and the system information may be referred to as an SSB (SS/PBCH block). As shown in FIG. 1, the base station 10 transmits a control signal or data in DL (Downlink) to the terminal 20 and receives a control signal or data in UL (Uplink) from the terminal 20. The base station 10 and terminal 20 are capable of transmitting and receiving a signal by performing the beamforming. Further, the base station 10 and the terminal 20 can both apply MIMO (Multiple Input Multiple Output) communication to DL or UL. Further, the base station 10 and the terminal 20 may both perform communications via a secondary cell (SCell: Secondary Cell) and a primary cell (PCell: Primary Cell) using CA (Carrier Aggregation). In addition, the terminal 20 may perform communications via a primary cell of the base station 10 and a primary secondary cell group cell (PSCell: Primary SCG Cell) of another base station 10 using DC (Dual Connectivity).

The terminal 20 may be a communication apparatus that includes a wireless communication function such as a smartphone, a mobile phone, a tablet, a wearable terminal, a communication module for M2M (Machine-to-Machine), or the like. As shown in FIG. 1, the terminal 20 uses various communication services provided by the wireless communication system by receiving control signals or data in DL from the base station 10 and transmitting control signals or data in UL to the base station 10. In addition, the terminal 20 receives various reference signals transmitted from the base station 10 and performs measurement of the propagation path quality based on the reception result of the reference signals.

The terminal 20 is capable of performing carrier aggregation in which a plurality of cells (a plurality of CCs (Component Carrier) ) are bundled for performing communication with the base station 10. In the carrier aggregation, one PCell (Primary cell) and one or more SCells (Secondary cell) are used. In addition, PUCCH-SCell having PUCCH may be used.

The conventional NR Release 17 RedCap will be described. The maximum bandwidth that is supported by a RedCap UE and that is being discussed in NR Release 17 is 20 MHz in FR1 (Frequency Range 1) and 100 MHz in FR2 (Frequency Range 2). In addition, the RedCap UE is required to coexist with a non RedCap UE (hereinafter, also referred to as “non-RedCap UE”) within the system.

In addition, a RedCap UE and a non-RedCap UE may be enabled to share the same initial DL-BWP (Downlink Bandwidth part) (including the subcarrier spacing, bandwidth, and position) configured by MIB (Master Information Block). On the other hand, an initial DL-BWP having a separate or added subcarrier spacing, bandwidth, and position for the RedCap UE may be configured.

The RedCap UE can share the initial DL-BWP for non-RedCap UE (hereinafter, also referred to as “DL-BWP #0”) in a case where the maximum bandwidth supported by the RedCap UE is not exceeded.

In addition, according to the NR Release 17 technical specification, in a case of TDD, a DL-BWP and a UL-BWP with the same index must have the same center frequency in order to avoid the RF retuning.

In addition, a RedCap UE expects that an initial DL-BWP and an active DL-BWP are to be equal to or less than the maximum DL bandwidth supported by the RedCap UE after the (re)establishment of the dedicated RRC connection. The RedCap UE is provided with a DL-BWP by “initialDownlinkBWP” in “DownlinkConfigCommonRedCapSIB”, and is provided with a UL-BWP by “initialUplinkBWP” in “UplinkConfigCommonRedCapSIB”. In a case where “initialUplinkBWP” in “UplinkConfigCommonSIB” indicates a UL-BWP that is larger than the maximum UL-BWP supported by the RedCap UE, the RedCap UE expects that a UL-BWP is to be provided by “initialUplinkBWP” in “UplinkConfigCommonRedCapSIB”.

The RedCap UE may be provided with a DL-BWP by “BWP-DownlinkDedicated” other than the initial DL-BWP. The RedCap UE may be provided with a UL-BWP that is equal to or less than the maximum UL bandwidth supported by the RedCap UE by “BWP-UplinkDedicated” other than the initial UL-BWP.

In a case where a RedCap UE is provided with “RACH-ConfigCommon-RedCap” or “RACH-ConfigCommonTwoStepRA-RedCap”, the RedCap UE performs an initial access and random access procedure by using the corresponding parameters. Otherwise, the RedCap UE uses the corresponding parameters provided by “RACH-ConfigCommon” or “RACH-ConfigCommonTwoStepRA”.

In a case where the RedCap UE is provided with “initialUplinkBWP” by “UplinkConfigCommonRedCapSIB” and there is no dedicated PUCCH resource configuration, the RedCap UE transmits PUCCH with HARQ-ACK information by using the PUCCH resource set provided by “pucch-ResourceCommonRedCap”. It is to be noted that the PUCCH transmission is disabled in a case where “disable-FH-PUCCH” is provided by “PUCCH-ConfigCommonRedCap”.

In a case of an initial DL-BWP that is provided by “initialDownlinkBWP” of “DownlinkConfigCommonRedCapSIB”, when a RedCap UE monitors PDCCH according to the Type1-PDCCH CSS (Common search space) set without monitoring PDCCH according to the Type2-PDCCH CSS set, the RedCap UE recognizes that the initial DL-BWP does not include an SS/PBCH block or a CORESET (Control resource set) with index 0.

In a case where the RedCap UE monitors PDCCH according to the Type2-PDCCH CSS set, the RedCap UE assumes that the initial DL-BWP includes an SS/PBCH block and the CORESET with an index 0 if the RedCap UE has obtained SIB 1 by using the SS/PBCH block and assumes that the initial DL-BWP includes an SS/PBCH block and does not include the CORESET with an index 0 if the initial DL-BWP does not include the SS/PBCH block that the RedCap UE has used to obtain SIB1.

In a case of an active DL-BWP provided by “BWP-DownlinkDedicated”, the RedCap UE assumes that the active DL-BWP includes an SS/PBCH block and that the active DL-BWP does not include the CORESET with an index 0 except for a case of indicating a function of performing an operation using the DL-BWP without receiving an SS/PBCH block.

Next, the NR Release 18 RedCap will be described. In the NR Release 18, the eRedCap for further reducing the complexity of the RedCap UE for the NR Release 17 is being discussed. The capability reduced terminal for NR Release 17 is referred to as a RedCap UE and the enhanced capability reduced terminal for NR Release 18 is referred to as an eRedCap UE.

The impact on the network, co-existence of the RedCap UE or eRedCap UE with non-RedCap UE in a cell, impact on UE, impact on technical specifications, and the like are being discussed. The potential solutions, which may complement each other, for reducing the device complexity are focused on the following.

Reduction of the UE bandwidth in FR1 to 5 MHz is being discussed as the first solution. This solution may be combined with the relaxed UE processing timeline for PDSCH and/or PUSCH and/or CSI to be specified in the technical specifications.

The reduced UE peak data rate in FR1 is being discussed as the second solution. This solution may include the limited bandwidth for PDSCH and/or PUSCH, and may be combined with the relaxed UE processing timeline for PDSCH and/or PUSCH and/or CSI to be specified in the technical specifications.

It is to be noted that the following points are required to be taken into account with respect to the eRedCap UE. That is, the SSB that has been specified in the technical specifications of NR Release 15 is required to be reused so that the L1 changes are minimized. In addition, the BWP operations with/without SSB and with/without RF retuning are required to be discussed. Furthermore, it is not precluded that some solutions for FR1 can be applied to FR2. In addition, defining a single type of a Release 18 capability-reduced terminal for further reducing the UE complexity is being discussed.

The eRedCap UE may be defined as described below.

For example, in the random access procedure, a terminal 20 that indicates that the terminal 20 itself is an eRedCap UE in at least one of the Msg1, Msg3, or MsgA may be defined to be an eRedCap UE.

For example, a terminal 20 that supports a specific UE capability may be defined as an eRedCap UE. The specific UE capability may be 1) to 7) described below, for example.
1) Capability of supporting up to 5 MHz bandwidth for PDSCH and PUSCH in FR1.
2) Capability of supporting the relaxed UE processing time for PDSCH, PUSCH, and/or CSI.
3) Capability of supporting the reduced UE peak data rate in FR1.
4) Capability of supporting one or two reception branches and the corresponding maximum number of DL-MIMO layers.
5) Capability of supporting FD (Full Duplex) FDD or Type A HD (Half Duplex)-FDD in the FR1 FDD band.
6) Capability of supporting 64QAM (Quadrature amplitude modulation) or 256QAM in FR1.
7) Capability of not supporting carrier aggregation or dual connectivity.

In addition, a terminal 20 that reports to the base station 10 through the UE capability report that the terminal 20 supports a specific UE capability may be defined as an eRedCap UE. It is to be noted that the conventional terminal in an embodiment of the present invention may mean a terminal other than the eRedCap UE.

Although the RF bandwidth of the eRedCap UE is 20 MHz, the bandwidth of transmission and reception of the data channel is limited to 5 MHz.

The bandwidth that can be processed by the eRedCap UE on a per-slot basis is limited to 5 MHz. In order for an eRedCap UE to perform a process of receiving PDSCH by using the PDSCH processing time that is the same as that of the conventional terminal, the number of RBs (Resource Blocks) exceeding 5 MHz cannot be allocated with respect to the unicast PDSCH that the eRedCap UE receives.

On the other hand, with respect to the conventional terminal, a unicast PDSCH and a broadcast PDSCH can be frequency-division multiplexed in the overlapped time resource in the same slot.

In a case where a unicast PDSCH and a broadcast PDSCH that have a bandwidth of 5 MHz or less are frequency-division multiplexed in the same slot, the total bandwidth (the number of RBs) of the unicast PDSCH and the broadcast PDSCH may exceed 5 MHz. As described above, in a case where the total bandwidth exceeds the bandwidth that can be processed by an eRedCap UE when a plurality of PDSCHs per slot are frequency-division multiplexed, there is a possibility that the eRedCap UE cannot receive the PDSCHs.

### Embodiment Overview and Basic Operation Example

According to an embodiment of the present invention, the method and the limitation of frequency-division multiplexing of a plurality of PDSCHs in the same slot for the terminal 20 that has a capability of processing a predetermined bandwidth or less per slot will be specified in the technical specification. The technical specification is, for example, a 3GPP technical specification (e.g.: Technical Specification or Technical Report), and the terminal 20 operates in accordance with the technical specification. In other words, the terminal 20 is expected to use a method of frequency-division multiplexing of a plurality of PDSCHs in the same slot, the method being specified in the technical specification, and performs an operation based on the expectation.

According to an embodiment of the present invention, a terminal 20, that has a capability of processing a predetermined bandwidth or less per slot, can appropriately process PDSCHs that are scheduled to be frequency-division multiplexed in the same slot.

The terminal 20 in an embodiment of the present invention is a terminal from which a predetermined capability is reduced, and is, for example, an eRedCap UE. It is to be noted that the terminal 20 is not limited to an eRedCap UE, and may be a RedCap UE or a conventional terminal. The conventional terminal is, for example, an eRedCap UE and a terminal other than the RedCap UE.

PDSCH in an embodiment of the present invention is an example of a shared channel.

A slot in an embodiment of the present invention is an example of a unit indicating a unit time.

A bandwidth in an embodiment of the present invention is, for example, the number of RBS.

In an embodiment of the present invention, the terminal 20 has a capability of processing a baseband of a bandwidth of 5 MHz or less per slot, for example. It is to be noted that the bandwidth that can be processed per slot by the terminal 20 is not limited to 5 MHz, and may be any bandwidth. 5 MHz, which is the bandwidth in the following first to fourth embodiment, is an example of a bandwidth per slot that can be processed by the terminal 20.

The unicast PDSCH in an embodiment of the present invention may be a PDSCH that is scheduled by at least one of C-RNTI, MCS-C-RNTI, or CS-RNTI. However, the unicast PDSCH is not limited to the PDSCH described above, and may be any PDSCH that is transmitted by unicast.

The broadcast PDSCH in an embodiment of the present invention may be a PDSCH that is scheduled by at least one of SI-RNTI, P-RNTI, RA-RNTI, or TC-RNTI. However, the broadcast PDSCH is not limited to the PDSCH described above, and may be any PDSCH that is transmitted by broadcast.

In an embodiment of the present invention, the PDSCHs that are frequency-division multiplexed in a slot may be partially overlapped in the time domain, may be entirely overlapped, or are not required to be overlapped (in a case of being scheduled in the same slot).

### First Embodiment

According to the first embodiment, the supporting of the frequency-division multiplexing of a unicast PDSCH and one or more broadcast PDSCHs in the same slot is specified in the technical specification. The terminal 20 assumes an operation that is specified in the first embodiment and processes PDSCHs that are scheduled to be frequency-division multiplexed.

### Option 1-1

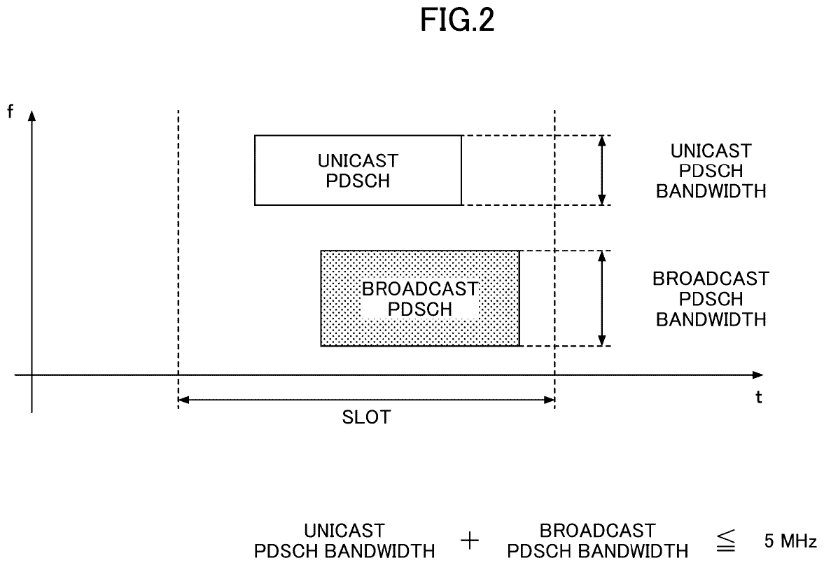

For example, as illustrated in FIG. 2, a total of a bandwidth that is allocated to a unicast PDSCH and a bandwidth that is allocated to a broadcast PDSCH may be specified not to exceed 5 MHz per slot.

It is to be noted that although FIG. 2 illustrates an example in which one unicast PDSCH and one broadcast PDSCH are frequency-division multiplexed per slot, the Option 1-1 may be applied to a case in which one unicast PDSCH and two or more broadcast PDSCHs are frequency-division multiplexed per slot.

### Option 1-2

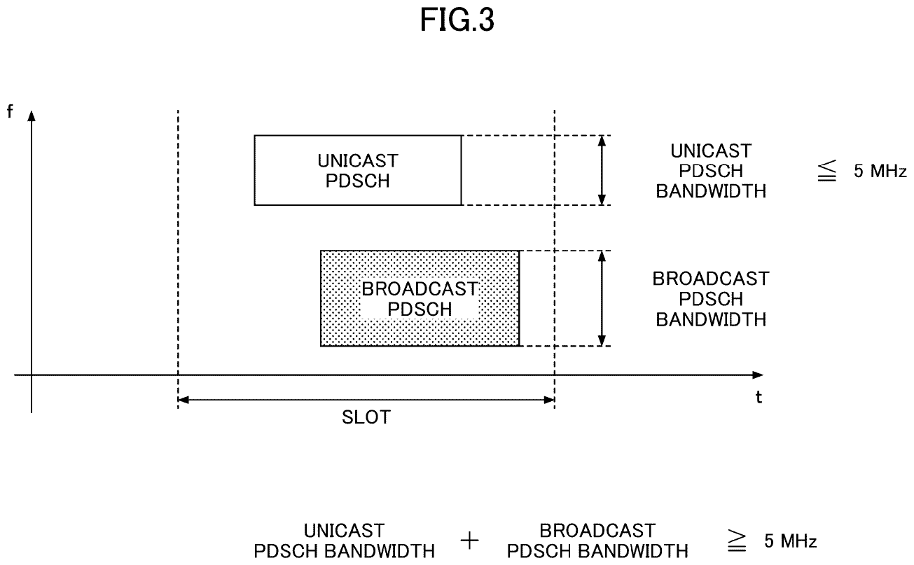

For example, as illustrated in FIG. 3, a bandwidth that is allocated to a unicast PDSCH may be specified not to exceed 5 MHz and a total of the bandwidth that is allocated to the unicast PDSCH and a bandwidth that is allocated to a broadcast PDSCH may be specified to exceed 5 MHz.

It is to be noted that although FIG. 3 illustrates an example in which one unicast PDSCH and one broadcast PDSCH are frequency-division multiplexed per slot, the Option 1-2 may be applied to a case in which one unicast PDSCH and two or more broadcast PDSCHs are frequency-division multiplexed per slot.

In an example illustrated in FIG. 3, an upper limit value of the total bandwidth of the unicast PDSCH and the broadcast PDSCH may be specified. In addition, the upper limit value of the total bandwidth of the unicast PDSCH and the broadcast PDSCH may be specified by the technical specification, or may be configured according to the UE capability.

In addition, in an example illustrated in FIG. 3, the bandwidth that is allocated to the broadcast PDSCH may be specified not to exceed 5 MHz.

In addition, in an example illustrated in FIG. 3, the bandwidth that is allocated to the broadcast PDSCH may be specified to exceed 5 MHz.

In the first embodiment, an overlap between the SI (System Information) acquisition processing period and the unicast PDSCH time resource may be supported.

### Second Embodiment

According to the second embodiment, the supporting of the frequency-division multiplexing of two broadcast PDSCHs in the same slot is specified in the technical specification. The terminal 20 is expected to perform an operation that is specified in the first embodiment and processes PDSCHs that are scheduled to be frequency-division multiplexed.

### Option 2A

In a case where a PDSCH that is scheduled by RA (Random Access)-RNTI (Radio Network Temporary Identifier) is frequency-division multiplexed with another PDSCH in the same slot, the timeline between Msg2 PDSCH and Msg3 PUSCH (N_{T,1}+N_{T,2}+0.5 msec specified in 3GPP TS 38.213 ) may be enhanced in accordance with the following Option 2A-1 to Option 2A-3.

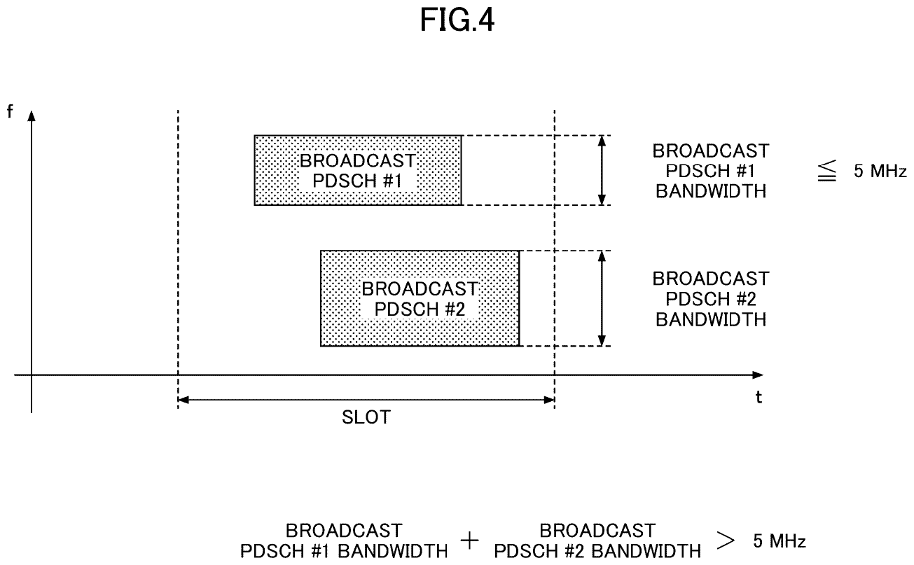

In FIGS. 4 to 6, the broadcast PDSCH #1 is a PDSCH that is scheduled by RA-RNTI, and the broadcast PDSCH #2 is another PDSCH.

### Option 2A-1

For example, as illustrated in FIG. 4, the timeline between Msg2 PDSCH and Msg3 PUSCH may be enhanced in a case where one of the two bandwidths that are allocated to two broadcast PDSCHs per slot does not exceed 5 MHz and a total of the bandwidths that are allocated to the two PDSCHs exceeds 5 MHz. Although a case is illustrated in FIG. 4 in which the bandwidth of the broadcast PDSCH #1 does not exceed 5 MHz, the case may be a case in which the bandwidth of the broadcast PDSCH #2 (instead of the broadcast PDSCH #1) does not exceed 5 MHz.

### Option 2A-2

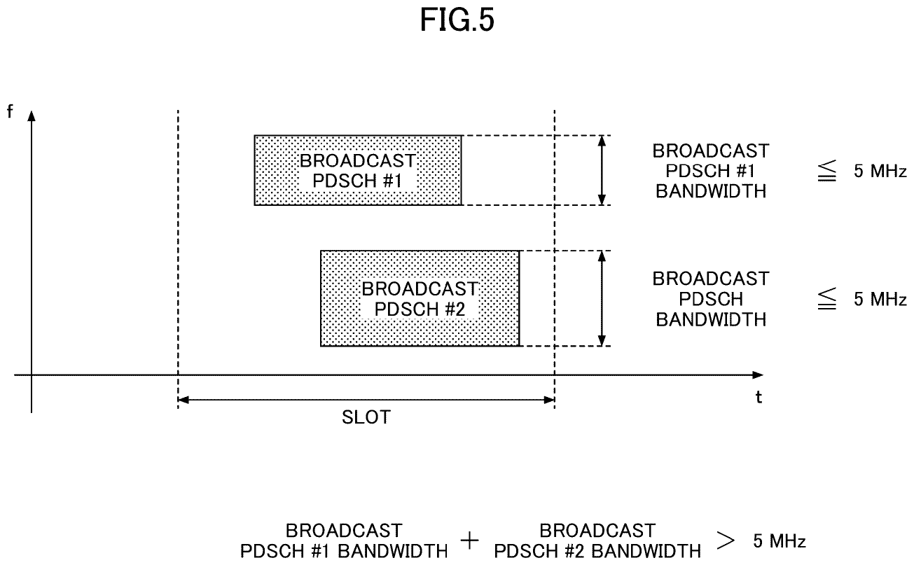

For example, as illustrated in FIG. 5, the timeline between Msg2 PDSCH and Msg3 PUSCH may be enhanced in a case where each of the two bandwidths that are allocated to two broadcast PDSCHs per slot does not exceed 5 MHz and a total of the bandwidths that are allocated to the two PDSCHs exceeds 5 MHz.

### Option 2A-3

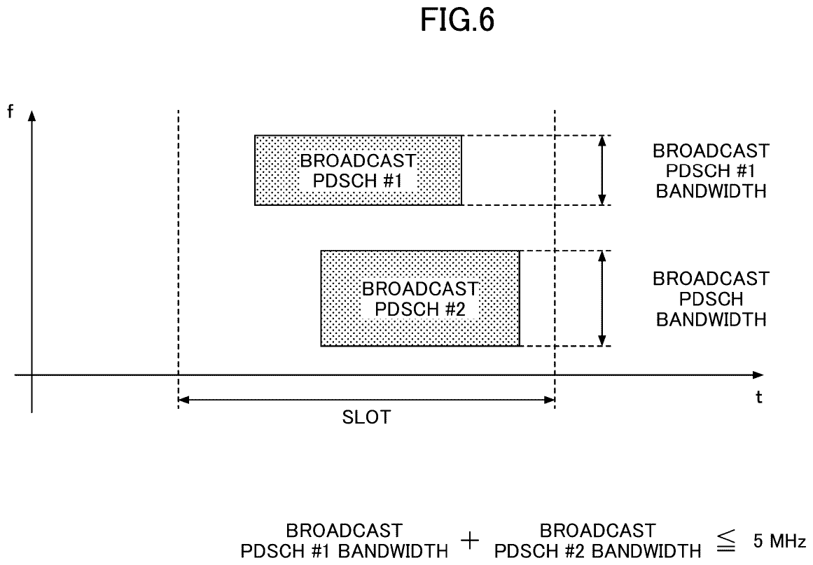

For example, as illustrated in FIG. 6, the timeline between Msg2 PDSCH and Msg3 PUSCH may be enhanced in a case where a total of the bandwidths that are allocated to two PDSCHs per slot does not exceed 5 MHz.

### Option 2B

In a case where a PDSCH that is scheduled by TC (Temporary C)-RNTI is frequency-division multiplexed with another PDSCH in the same slot, the PDSCH processing time (N_{T,1}+0.5 msec specified in 3GPP TS 38.213 ) may be enhanced in accordance with the following Option 2B-1 to Option 2B-3. The TC-RNTI is included in the random access response.

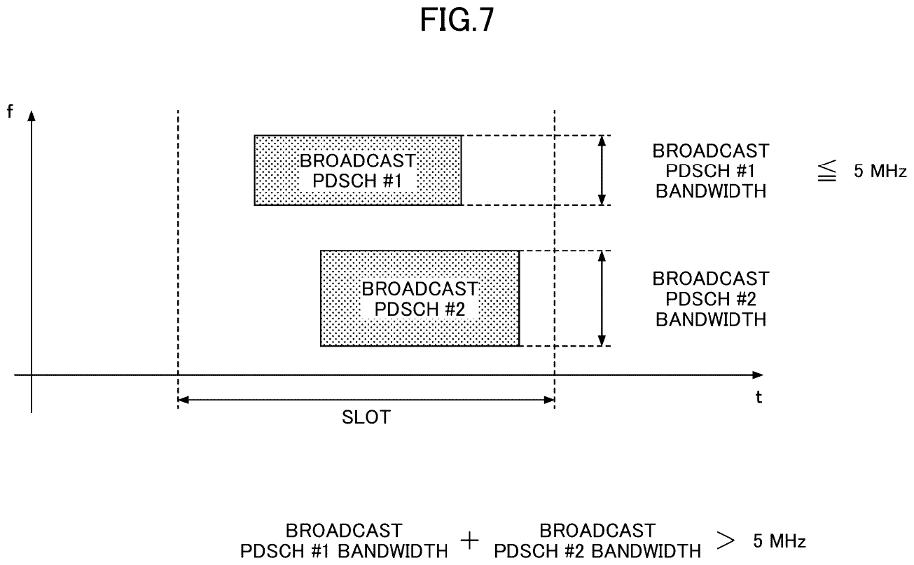

In FIGS. 7 to 9, the broadcast PDSCH #1 is a PDSCH that is scheduled by TC-RNTI, and the broadcast PDSCH #2 is another PDSCH.

### Option 2B-1

For example, as illustrated in FIG. 7, the PDSCH processing time may be enhanced in a case where one of the bandwidths that are allocated to two broadcast PDSCHs per slot does not exceed 5 MHz and a total of the bandwidths allocated to the two PDSCHs exceeds 5 MHz. Although a case is illustrated in FIG. 7 in which the bandwidth of the broadcast PDSCH #1 does not exceed 5 MHz, the case may be a case in which the bandwidth of the broadcast PDSCH #2 (instead of the broadcast PDSCH #1) does not exceed 5 MHz.

### Option 2B-2

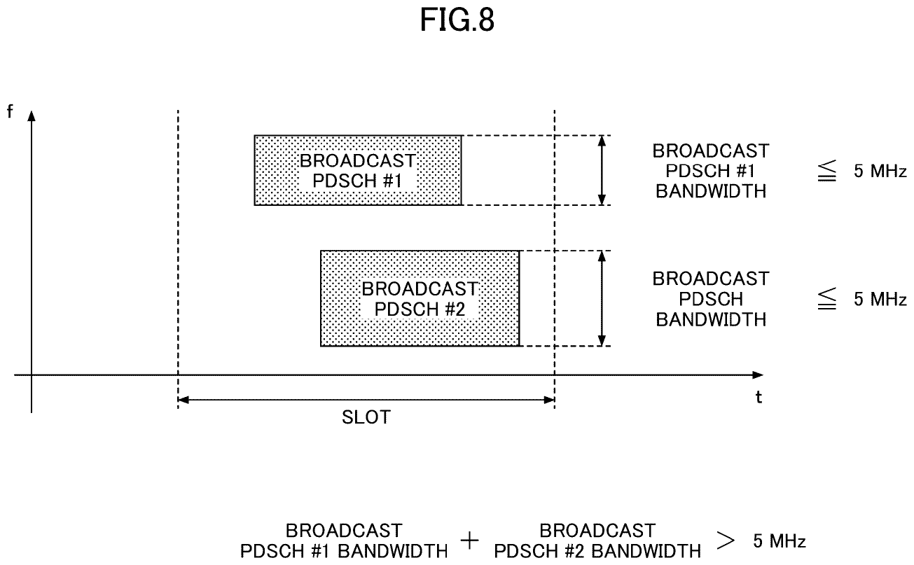

For example, as illustrated in FIG. 8, the PDSCH processing time may be enhanced in a case where each of the bandwidths that are allocated to two broadcast PDSCHs per slot does not exceed 5 MHz and a total of the bandwidths allocated to the two PDSCHs exceeds 5 MHz.

### Option 2B-3

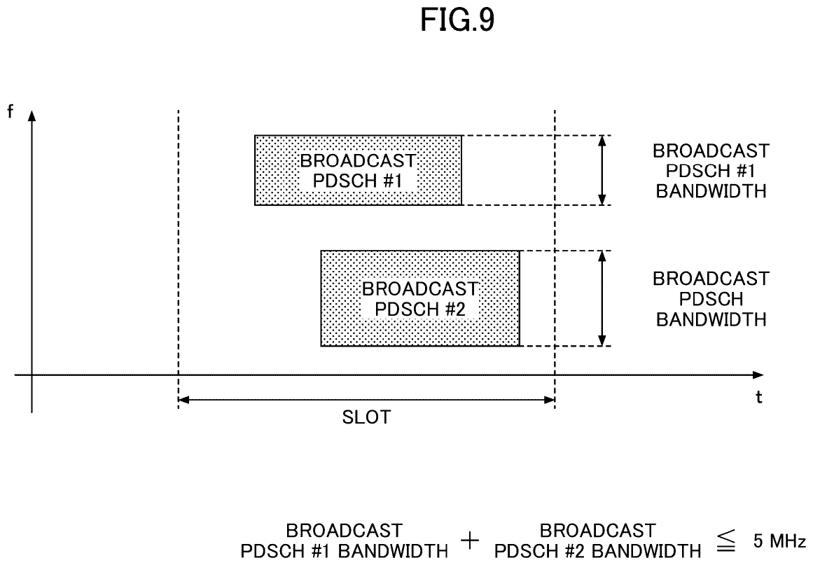

For example, as illustrated in FIG. 9, the PDSCH processing time may be enhanced in a case where a total of the bandwidths that are allocated to two PDSCHs per slot does not exceed 5 MHz.

### Third Embodiment

According to the third embodiment, no support of the frequency-division multiplexing of a plurality of PDSCHs in the same slot by the terminal 20 is specified in the technical specification. The terminal 20 assumes an operation that is specified in the third embodiment and performs a process of PDSCH reception based on this assumption.

### Option 3-1

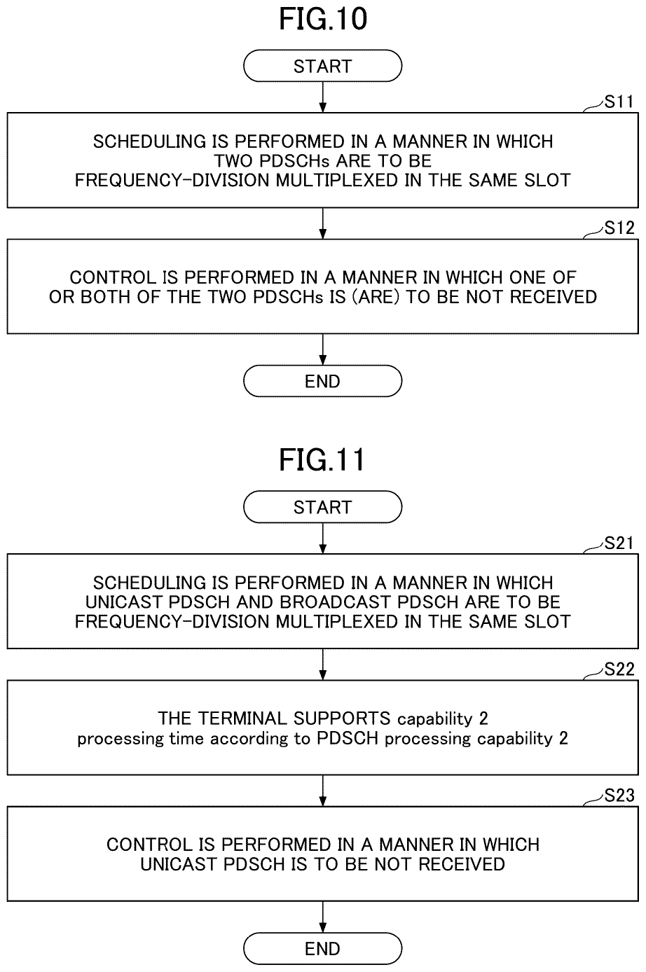

For example, as illustrated in FIG. 10, in a case where two PDSCHs are scheduled to be frequency-division multiplexed per slot (step S11), one of or both of the two PDSCHs may be specified to be not received (step S12). The terminal 20 performs a control in a manner in which one of or both of the two PDSCHs is (are) to be received. It is to be noted that the operation of not receiving a PDSCH in an embodiment of the present invention may be replaced with an operation of skipping the PDSCH reception or an operation of dropping the PDSCH.

In a case where scheduling is performed in a manner in which three or more PDSCHs are scheduled to be frequency-division multiplexed per slot, all PDSCHs, from among the PDSCHS, other than the PDSCH that is to be received may be specified to be not received.

In a case where scheduling is performed in a manner in which three or more PDSCHs are scheduled to be frequency-division multiplexed per slot, all of the scheduled PDSCHs may be specified to be not received.

### Option 3-2

For example, as illustrated in FIG. 11, in a case where scheduling is performed in a manner in which a unicast PDSCH and a broadcast PDSCH are frequency-division multiplexed in the same slot (step S21), because the terminal 20 supports capability 2 processing time according to PDSCH processing capability 2 (step S22), the terminal 20 may perform a control of not receiving the unicast PDSCH (step S23).

The UE capability parameters that are parameters indicating the capability of the terminal 20 include pdsch-ProcessingType2. The pdsch-ProcessingType2 indicates whether or not the terminal 20 supports PDSCH processing capability 2. In addition, the pdsch-ProcessingType2 indicates whether or not the terminal 20 supports the PDSCH capability 2 processing time.

According to a modified embodiment of the third embodiment, for example, the terminal 20 is not required to support an overlap between the SI acquisition processing period and the unicast PDSCH time resource.

### Fourth Embodiment

According to the fourth embodiment, the UE capability may indicate which option of the above-described first to third embodiments is supported by the terminal 20. In addition, capability signaling for reporting which option of the above-described first to third embodiments is supported by the terminal 20 may be specified.

For example, an upper limit value of the total number of resource blocks of a plurality of PDSCHs that are frequency-division multiplexed in a slot may be specified. The upper limit value of the total number of resource blocks of a plurality of PDSCHs per slot may be indicated by UE capability. According to the above-described configuration of the UE capability, the upper limit value of the total number of resource blocks of a plurality of PDSCHs per slot can be differently configured for each terminal 20.

According to a modified embodiment of the fourth embodiment, the PDSCH processing time capability to be applied may vary depending on the option supported by the terminal 20 from among the options of the above-described first to third embodiments.

For example, a new PDSCH processing time capability indicating the PDSCH processing time that is applied in accordance with an option supported by the terminal 20 from among the options of the above-described first to third embodiments may be specified. In a case where a plurality of PDSCHs are frequency-division multiplexed per slot, the PDSCH processing time capability may be applied.

The new PDSCH processing time capability may be specified as a value that is greater than the PDSCH processing capability 1 with respect to at least one of 15 KHz SCS/30 KHz SCS/60 KHz SCS.

The support of the PDSCH processing capability 2 may be specified as a prerequisite capability.

According to the above-described embodiments, a terminal that has a baseband processing capability of a predetermined bandwidth or less per unit time can appropriately control a process of receiving shared channels that are frequency-division multiplexed in the unit time.

### Device Configuration

Next, a functional configuration example of the base station 10 and the terminal 20 for performing the processes and operations described above will be described. The base station 10 and the terminal 20 include functions for implementing the embodiments described above. It should be noted, however, that each of the base stations 10 and the terminal 20 may include only some of the functions in an embodiment.

### Base Station 10

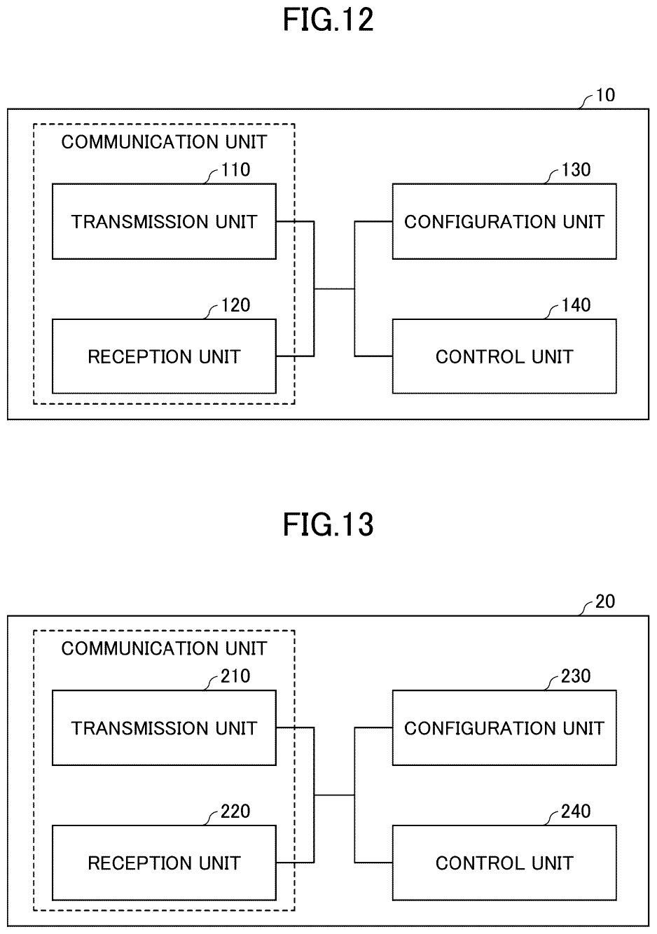

FIG. 12 is a drawing illustrating an example of a functional structure of a base station 10 in an embodiment of the present invention. As shown in FIG. 12, the base station 10 includes a transmission unit 110, a reception unit 120, a configuration unit 130, and a control unit 140. The functional configuration illustrated in FIG. 12 is merely an example. Functional divisions and names of functional units may be any division and name as long as operations related to an embodiment of the present invention can be performed.

The transmission unit 110 includes a function for generating a signal to be transmitted to the terminal 20 side and transmitting the signal wirelessly. Further, the transmission unit 110 transmits an inter-network-node message to another network node. The reception unit 120 includes a function for receiving various signals transmitted from the terminal 20 and acquiring, for example, information of a higher layer from the received signals. In addition, the transmission unit 110 has a function of transmitting NR-PSS, NR-SSS, NR-PBCH, DL/UL control signals, and the like to the terminal 20. Further, the reception unit 120 receives an inter-network-node message from another network node.

The configuration unit 130 stores preset information and various configuration information items to be transmitted to the terminal 20. Contents of the configuration information are, for example, information related to the scheduling, or the like.

The control unit 140 performs control that enables functions described in an embodiment of the present invention. In addition, the control unit 140 performs control related to the scheduling as described in an embodiment of the present invention. The functional units related to signal transmission in the control unit 140 may be included in the transmission unit 110, and the functional units related to signal reception in the control unit 140 may be included in the reception unit 120.

### Terminal 20

FIG. 13 is drawing illustrating an example of a functional structure of a terminal 20 in an embodiment of the present invention. As shown in FIG. 13, the terminal 20 includes a transmission unit 210, a reception unit 220, a configuration unit 230, and a control unit 240. The functional configuration illustrated in FIG. 13 is merely an example. Functional divisions and names of functional units may be any division and name as long as operations related to an embodiment of the present invention can be performed.

The transmission unit 210 generates a transmission signal from transmission data and transmits the transmission signal wirelessly. The reception unit 220 receives various signals wirelessly and obtains higher layer signals from the received physical layer signals. In addition, the reception unit 220 has a function of receiving NR-PSS, NR-SSS, NR-PBCH, DL/UL/SL control signals, and the like, transmitted from the base station 10. In addition, for example, with respect to the D2D communications, the transmission unit 210 transmits, to another terminal 20, PSCCH (Physical Sidelink Control Channel), PSSCH (Physical Sidelink Shared Channel), PSDCH (Physical Sidelink Discovery Channel), PSBCH (Physical Sidelink Broadcast Channel), etc., and the reception unit 220 receives, from the another terminal 20, PSCCH, PSSCH, PSDCH, PSBCH, etc.

The configuration unit 230 stores various configuration information items received by the reception unit 220 from the base station 10. In addition, the configuration unit 230 also stores pre-configured configuration information. Contents of the configuration information are, for example, information related to the scheduling, or the like.

The control unit 240 performs control that enables functions described in an embodiment of the present invention. In addition, the control unit 240 performs control related to the scheduling as described in an embodiment of the present invention. The functional units related to signal transmission in the control unit 240 may be included in the transmission unit 210, and the functional units related to signal reception in the control unit 240 may be included in the reception unit 220.

### Hardware Structure

The block diagrams that have been used to describe the above embodiments (FIG. 12 and FIG. 13) show blocks in functional units. These functional blocks (components) may be implemented in arbitrary combinations of at least one of hardware or software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these.

For example, the functional block (component) to implement a function of transmission may be referred to as a transmitting unit or a transmitter. The method for implementing each component is not particularly limited as described above.

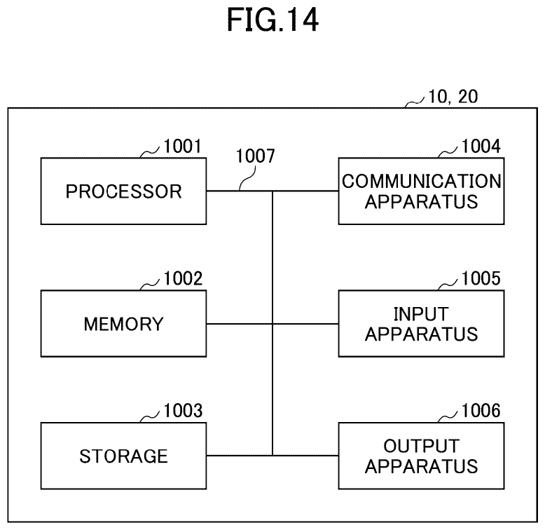

For example, the base station 10, the terminal 20, etc., according to an embodiment of the present disclosure may function as a computer for processing the radio communication method of the present disclosure. FIG. 14 is a diagram to show an example of a hardware structure of the base station 10 and the terminal 20 according to one embodiment. Physically, the above-described base station 10 and terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the terminal 20 may be configured to include one or more of apparatuses shown in the drawings, or may be configured not to include part of apparatuses.

Each function of the base station 10 and the terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading or writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, the above-described control unit 140, control unit 240, and so on may be implemented by the processor 1001.

Furthermore, the processor 1001 reads programs (program codes), software modules, data, or the like, from at least one of the storage 1003 and the communication apparatus 1004, into the memory 1002, and executes various processes according to these. As for the programs, programs to allow computers to execute at least part of the operations of the above-described embodiments are used. For example, the control unit 140 of the base station 10 illustrated in FIG. 12 may be implemented by control programs that are stored in the memory 1002 and that operate on the processor 1001. In addition, for example, the control unit 240 of the terminal 20 illustrated in FIG. 13 may be implemented by control programs that are stored in the memory 1002 and that operate on the processor 1001. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically Erasable Programmable ROM (EEPROM), a Random Access Memory (RAM), or other appropriate storage media. The memory 1002 may be referred to as a “register,” a “cache,” a “main memory (primary storage apparatus) ” and so on. The memory 1002 can store executable programs (program codes), software modules, and the like for implementing the communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, other appropriate storage media. The above recording medium may be a database including the memory 1002 and/or the storage 1003, a server, or any other appropriate medium.

The communication apparatus 1004 is hardware (transmitting/receiving device) for allowing inter-computer communication via at least one of wired or wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) or time division duplex (TDD). For example, the transmitting/receiving antenna, the amplifier unit, the transmitting/receiving unit, the transmission line interface, and the like, may be implemented by the communication apparatus 1004. The transmitting/receiving unit may be implemented by physically or logically being divided into a transmitting unit and a receiving unit.

The input apparatus 1005 is an input device that receives input from the outside (for example, a keyboard, a mouse, a microphone, a switch, a button, a sensor, and so on). The output apparatus 1006 is an output device that outputs something to the outside (e.g., display, speaker, LED lamp). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

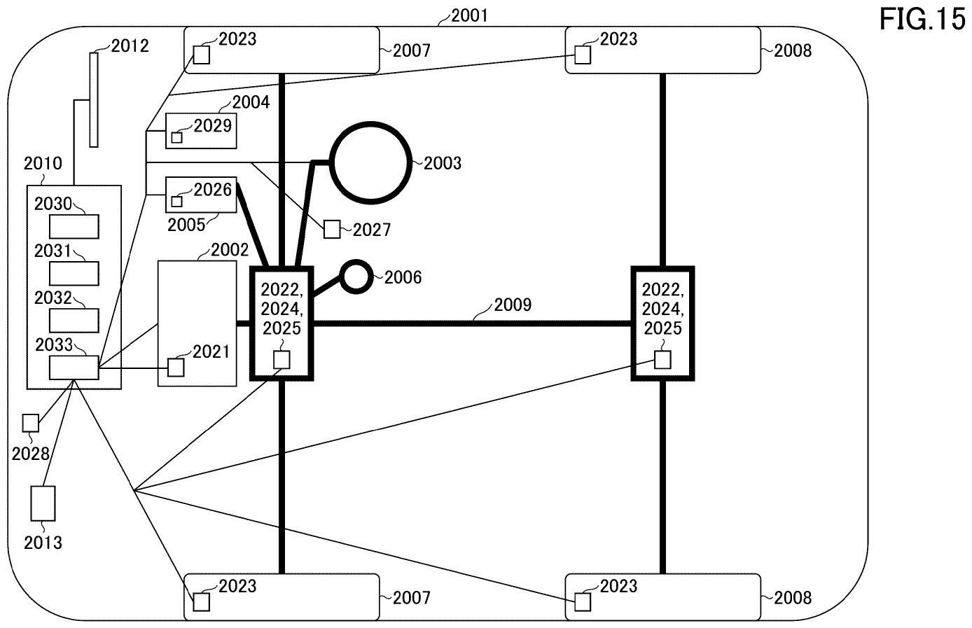

FIG. 15 shows an example of a configuration of a vehicle 2001. As shown in FIG. 15, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021-2029, an information service unit 2012, and a communication module 2013. The aspects/embodiments described in the present disclosure may be applied to a communication device mounted in the vehicle 2001, and may be applied to, for example, the communication module 2013.

The drive unit 2002 may include, for example, an engine, a motor, and a hybrid of an engine and a motor. The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-2029 provided in the vehicle 2001. The electronic control unit 2010 may be referred to as an ECU (Electronic control unit).

The signals from the various sensors 2021 to 2029 include a current signal from a current sensor 2021 that senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing (outputting) various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like. The information service unit 2012 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving support system unit 2030 includes: various devices for providing functions of preventing accidents and reducing driver's operating loads such as a millimeter wave radar, a LiDAR (Light Detection and Ranging), a camera, a positioning locator (e. g., GNSS, etc.) , map information (e. g., high definition (HD) map, autonomous vehicle (AV) map, etc.), a gyro system (e.g., IMU (Inertial Measurement Unit), INS (Inertial Navigation System), etc. ), an AI (Artificial Intelligence) chip, an AI processor; and one or more ecus controlling these devices. In addition, the driving support system unit 2030 transmits and receives various types of information via the communication module 2013 to realize a driving support function or an autonomous driving function.

The communication module 2013 can communicate with the microprocessor 2031 and components of the vehicle 2001 via a communication port. For example, the communication module 2013 transmits and receives data via a communication port 2033, to and from a drive unit 2002, a steering unit 2003, an accelerator pedal 2004, a brake pedal 2005, a shift lever 2006, front wheels 2007, rear wheels 2008, an axle 2009, a microprocessor 2031 and a memory (ROM, RAM) 2032 in the electronic control unit 2010, and sensors 2021 to 2029 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 may transmit at least one of signals from the various sensors 2021 to 2028 described above input to the electronic control unit 2010, information obtained based on the signals, and information based on an input from the outside (a user) obtained via the information service unit 2012, to the external apparatus via radio communication. The electronic control unit 2010, the various sensors 2021 to 2028, the information service unit 2012, and the like may be referred to as input units that receive input. For example, the PUSCH transmitted by the communication module 2013 may include information based on the input.

The communication module 2013 receives various types of information (traffic information, signal information, inter-vehicle information, etc.) transmitted from the external devices and displays the received information on the information service unit 2012 provided in the vehicle 2001. The information service unit 2012 may be referred to as an output unit that outputs information (for example, outputs information to devices, such as a display, a speaker, or the like, based on the PDSCH received by the communication module 2013 (or data/information decoded from the PDSCH)). In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021-2029, etc., mounted in the vehicle 2001.

### Embodiment Summary

As described above, a terminal in an embodiment of the present invention includes: a control unit configured to control a process of reception of frequency-division multiplexed first shared channel and second shared channel; and a reception unit configured to receive the first shared channel and the second shared channel, based on the process of reception. The terminal has a capability of processing a predetermined bandwidth or less per unit time. The control unit controls the process of reception, based on the predetermined bandwidth, a first bandwidth that is allocated to the first shared channel, and a second bandwidth that is allocated to the second shared channel.

According to the above-described configuration, the terminal 20 that is an eRedCap UE can appropriately control a process of receiving shared channels that are frequency-division multiplexed, based on both the bandwidths that are allocated to a plurality of shared channels that are frequency-division multiplexed in a unit time and a predetermined bandwidth corresponding to the processing capability of the terminal 20.

With respect to the terminal in the above-described embodiment, the total bandwidth of the first bandwidth and the second bandwidth may be equal to or less than the predetermined bandwidth. According to the above-described configuration, the terminal 20 that is an eRedCap UE can appropriately control a process of receiving a plurality of shared channels, based on the bandwidths of a plurality of shared channels that are frequency-division multiplexed.

With respect to the terminal in the above-described embodiment, the first shared channel may be a unicast shared channel and the second shared channel may be a broadcast shared channel.

According to the above-described configuration, the terminal 20 that is an eRedCap UE can appropriately control a process of receiving the frequency-division multiplexed unicast shared channel and broadcast shared channel.

With respect to the terminal in the above-described embodiment, the first shared channel may be Msg2 PDSCH scheduled by RA-RNTI, and the control unit may enhance the timeline between Msg2 PDSCH and Msg3 PUSCH in a case where a total bandwidth of the first bandwidth and the second bandwidth exceeds the predetermined bandwidth. According to the above-described configuration, the terminal 20 that is an eRedCap UE can appropriately control a process of receiving a shared channel and another shared channel, the shared channel and the another shared channel being frequency-division multiplexed and the shared channel being scheduled by RA-RNTI.

With respect to the terminal in the above-described embodiment, the first shared channel may be a shared channel scheduled by TC-RNTI and the control unit may enhance the processing time of the shared channel in a case where a total bandwidth of the first bandwidth and the second bandwidth exceeds the predetermined bandwidth. According to the above-described configuration, the terminal 20 that is an eRedCap UE can appropriately control a process of receiving a shared channel and another shared channel, the shared channel and the another shared channel being frequency-division multiplexed and the shared channel being scheduled by TC-RNTI.

A communication method performed by a terminal in an embodiment of the present invention includes: controlling a process of reception of frequency-division multiplexed first shared channel and second shared channel; and receiving the first shared channel and the second shared channel, based on the process of reception. The terminal has a capability of processing a predetermined bandwidth or less per unit time. The controlling controls the process of reception, based on the predetermined bandwidth, a first bandwidth that is allocated to the first shared channel, and a second bandwidth that is allocated to the second shared channel.

According to the above-described configuration, the terminal 20 that is an eRedCap UE can appropriately control a process of receiving shared channels that are frequency-division multiplexed, based on both the bandwidths that are allocated to a plurality of shared channels that are frequency-division multiplexed in a unit time and a predetermined bandwidth corresponding to the processing capability of the terminal 20.

### Supplement of Embodiment

As described above, one or more embodiments have been described. The present invention is not limited to the above-described embodiments. A person skilled in the art should understand that there are various modifications, variations, alternatives, replacements, etc. of the embodiments. In order to facilitate understanding of the present invention, specific values have been used in the description. However, unless otherwise specified, those values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and flowcharts described in an embodiment of the present invention may be changed as long as there is no contradiction. For the sake of description convenience, the base station 10 and the terminal 20 have been described by using functional block diagrams. However, the apparatuses may be realized by hardware, software, or a combination of hardware and software. The software executed by a processor included in the base station 10 according to an embodiment of the present invention and the software executed by a processor included in the terminal 20 according to an embodiment of the present invention may each be stored in a random access memory (RAM), a flash memory, a read only memory (ROM), an EPROM, an EEPROM, a register, a hard disk (HDD), a removable disk, a CD-ROM, a database, a server, or any other appropriate recording medium.

In addition, notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling), and other signals or combinations of these. Also, RRC signaling may be referred to as an “RRC message,” and can be, for example, an RRC connection setup message, an RRC connection reconfiguration message, and so on.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal) ), Future Radio Access (FRA), New-Radio Access Technology (RAT), New Radio (NR), New radio access (NX), Future generation radio access (FX), Global System for Mobile communications (GSM (registered trademark) ), CDMA 2000, Ultra Mobile Broadband (UMB), IEEE 802.11 (Wi-Fi (registered trademark) ), IEEE 802.16 (WiMAX (registered trademark) ), IEEE 802.20, Ultra-WideBand (UWB), Bluetooth (registered trademark), systems that use other adequate radio communication methods, next-generation systems that are enhanced, modified, created, or defined based on these, and the like. In addition, a plurality of systems may be combined (for example, a combination of: at least one of LTE or LTE-A; and 5G, and the like) to be applied.

The order of processes, sequences, flowcharts, and so on that have been used to describe the aspects/embodiments in the present specification may be re-ordered as long as inconsistencies do not arise. For example, although various methods have been illustrated in the present disclosure with various components of steps in exemplary orders, the specific orders that are illustrated herein are by no means limiting.

Operations which have been described in the present specification to be performed by a base station 10 may, in some cases, be performed by an upper node of the base station 10. In a network including one or a plurality of network nodes with base stations 10, it is clear that various operations that are performed to communicate with terminals 20 can be performed by base stations 10, one or more network nodes (for example, Mobility Management Entities (MMEs), Serving-Gateways (S-GWs), and so on may be possible, but these are not limiting) other than base stations 10, or combinations of these. According to the above, a case is described in which there is a single network node other than the base station 10. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because various channels (e.g., PUCCH, PDCCH, or the like) and information elements may be identified by any suitable names, the various names assigned to these various channels and information elements are not used as limitations.

In the present disclosure, the terms “Base Station (BS) ”, “Radio Base Station”, “Base Station Apparatus”, “Fixed Station”, “NodeB”, “eNodeB (eNB) ”, “gNodeB (gNB) ”, “Access Point”, “Transmission Point”, “Reception Point”, “Transmission/Reception Point”, “Cell”, “Sector”, “Cell Group”, “Carrier”, “Component Carrier”, and the like, may be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station or a base station subsystem that provides communication services within this coverage.

In the present disclosure, transmitting information to the terminal by the base station may be referred to as instructing the terminal to perform any control and/or operation based on the information by the base station.

In the present disclosure, the terms “mobile station (MS), ” “user terminal,” “user equipment (UE), ” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station or a mobile station may be referred to as a “transmitting apparatus,” a “receiving apparatus,” a “radio communication apparatus,” and so on. Note that at least one of a base station or a mobile station may be a device mounted on a moving object or a moving object itself, and so on. The mobile station is an object that can move, and the moving speed can be any speed. In addition, a mobile station that is not moving is also included. Examples of the moving object include, but are not limited to, a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone (registered trademark), a multicopter, a quadcopter, a balloon, and an object mounted on any of these. The moving object may be a moving object that autonomously travels based on a direction for moving. The moving object may be a vehicle (for example, a car, an airplane, and the like), may be a moving object which moves unmanned (for example, a drone, an automatic operation car, and the like), or may be a robot (a manned type or unmanned type) . Note that at least one of a base station or a mobile station also includes an apparatus which does not necessarily move during communication operation. For example, at least one of the base station or the mobile station may be an IoT (Internet of Things) device such as a sensor.

Furthermore, the base station in the present disclosure may be interpreted as a user terminal. For example, each aspect/embodiment of the present disclosure may be applied to the structure in which communications between a base station and a user terminal is replaced with communications between a plurality of terminals 20 (for example, which may be referred to as Device-to-Device (D2D), Vehicle-to-Everything (V2X), and the like). In this case, terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station may have the functions of the user terminal described above.

As used herein, the term “determining” may encompasses a wide variety of actions. For example, “determining” may be regarded as judging, calculating, computing, processing, deriving, investigating, looking up (search, inquiry) (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing, and the like. That is, “determining” may be regarded as a certain type of action related to determining. Further, “decision” may be read as “assuming”, “expecting”, or “considering”, etc.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot,” and so on, depending on which standard applies.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of”and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two more elements. Thus, reference to the first and second elements does not imply that only two elements may be employed, or that the first element must precede the second element in some way.

“Means” included in the configuration of each of the above apparatuses may be replaced by “parts”, “circuits”, “devices”, etc.

In the case where the terms “include”, “including” and variations thereof are used in the present disclosure, these terms are intended to be comprehensive in the same way as the term “comprising”. Further, the term “or” used in the present specification is not intended to be an “exclusive or”.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may have a fixed time length (for example, 1 ms) that does not depend on the numerology.

Numerology may be a communication parameter applied to at least one of transmission or reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, or the like.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as PDSCH (or PUSCH) mapping type A. A PDSCH (or PUSCH) transmitted using a mini-slot may be referred to as PDSCH (or PUSCH) mapping type B.

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a transmission time interval, “TTI,” a plurality of consecutive subframes may be referred to as a “TTI,” or one slot or one mini-slot may be referred to as a “TTI.” In other words, at least one of a subframe or a TTI may be a subframe (1 ms) in the conventional LTE, may be a period shorter than 1 ms (for example, 1 to 13 symbols), or may be a period longer than 1 ms. It is to be noted that the unit representing TTI may be referred to as a slot, a mini-slot, or the like, instead of a subframe.

Here, a TTI refers to the minimum time unit of scheduling in radio communication, for example. For example, in LTE systems, a base station performs, for each terminal 20, scheduling of allocating radio resources (such as a frequency bandwidth and transmission power that can be used by each terminal 20) in TTI units. It is to be noted that the definition of the TTI is not limited to the above-described definition.

The TTI may be a transmission time unit for channel-encoded data packets (transport blocks), code blocks, codewords, or the like, or may be a unit of processing in scheduling, link adaptation, or the like. It is to be noted that, when a TTI is provided, a time period (for example, the number of symbols) to which transport blocks, code blocks, codewords, or the like are actually mapped may be shorter than the TTI.

It is to be noted that, in a case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a normal TTI (TTI in LTE Rel. 8 to Rel. 12), a long TTI, a normal subframe, a long subframe, a slot, or the like. A TTI that is shorter than a normal TTI may be referred to as a “shortened TTI,” a “short TTI,” a “partial or fractional TTI,” a “shortened subframe,” a “short subframe,” a “mini-slot, ” a “sub-slot, ” a “slot” and so on.

It is to be noted that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and having a TTI length equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of the numerology, and may be 12, for example. The number of subcarriers included in an RB may be determined based on the numerology.

In addition, an RB may include one or a plurality of symbols in the time domain, and may have a length of one slot, one mini-slot, one subframe, or one TTI. One TTI, one subframe, and the like, may each be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (Res). For example, one RE may correspond to a radio resource area including one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be identified by an RB index based on the common reference point of the carrier. PRBs may be defined by a certain BWP and may be numbered in the BWP.

A BWP may include a UL BWP and a DL BWP. One or a plurality of BWPs may be configured in one carrier for UE.

At least one of configured BWPs may be active, and the terminal 20 is not required to expect to transmit/receive a certain signal/channel outside the active BWP. It is to be noted that that a “cell”, a “carrier”, or the like, in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

In the present disclosure, where an article is added by translation, for example “a”, “an”, and “the”, the disclosure may include that the noun following these articles is plural.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

An aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### DESCRIPTION OF THE REFERENCE NUMERALS

10 Base station
110 Transmission unit
120 Reception unit
130 Configuration unit
140 Control unit
20 Terminal
210 Transmission unit
220 Reception unit
230 Configuration unit
240 Control unit
30 Core network
1001 Processor
1002 Memory
1003 Storage
1004 Communication apparatus
1005 Input apparatus
1006 Output apparatus
2001 Vehicle
2002 Drive unit
2003 Steering unit
2004 Accelerator pedal
2005 Brake pedal
2006 Shift lever
2007 Front wheel
2008 Rear wheel
2009 Axle
2010 Electronic control unit
2012 Information service unit
2013 Communication module
2021 Current sensor
2022 Revolution sensor
2023 Pneumatic sensor
2024 Vehicle speed sensor
2025 Acceleration sensor
2026 Brake pedal sensor
2027 Shift lever sensor
2028 Object detection sensor
2029 Accelerator pedal sensor
2030 Driving support system unit
2031 Microprocessor
2032 Memory (ROM, RAM)
2033 Communication port (IO port)

1. A terminal comprising:
a control unit configured to control a process of reception of frequency-division multiplexed first shared channel and second shared channel; and
a reception unit configured to receive the first shared channel and the second shared channel, based on the process of reception, wherein
the terminal has a capability of processing a predetermined bandwidth or less per unit time, and
the control unit controls the process of reception, based on the predetermined bandwidth, a first bandwidth that is allocated to the first shared channel, and a second bandwidth that is allocated to the second shared channel.

2. The terminal as claimed in claim 1, wherein
a total bandwidth of the first bandwidth and the second bandwidth is equal to or less than the predetermined bandwidth.

3. The terminal as claimed in claim 1, wherein
the first shared channel is a unicast shared channel, and
the second shared channel is a broadcast shared channel.

4. The terminal as claimed in claim 1, wherein
the first shared channel is a Msg2 PDSCH (Physical Downlink Shared Channel) scheduled by an RA (Random Access)-RNTI (Radio Network Temporary Identifier), and
the control unit applies an enhancement to a timeline between the Msg2 PDSCH and a Msg3 PUSCH (Physical Uplink Shared Channel) in a case where a total bandwidth of the first bandwidth and the second bandwidth exceeds the predetermined bandwidth.

5. The terminal as claimed in claim 1, wherein
the first shared channel is a shared channel scheduled by a TC (Temporary C)-RNTI, and
the control unit applies an enhancement to a processing time of the shared channel in a case where a total bandwidth of the first bandwidth and the second bandwidth exceeds the predetermined bandwidth.

6. A communication method performed by a terminal, the communication method comprising:
controlling a process of reception of frequency-division multiplexed first shared channel and second shared channel; and
receiving the first shared channel and the second shared channel, based on the process of reception, wherein
the terminal has a capability of processing a predetermined bandwidth or less per unit time, and
the controlling includes controlling the process of reception, based on the predetermined bandwidth, a first bandwidth that is allocated to the first shared channel, and a second bandwidth that is allocated to the second shared channel.
